(19) United States
(12) Patent Application Publication
(10) Pub. No.: US 2018/0215618 A1
(43) Pub. Date: Aug. 2, 2018

(54) MAXIMIZING STEAM METHANE REFORMER COMBUSTION EFFICIENCY BY PRE-HEATING PRE-REFORMED FUEL GAS

(71) Applicant: L'Air Liquide, Societe Anonyme pour l'Etude et l'Exploitation des Procedes Georges Claude, Paris (FR)

(72) Inventors: Taekyu KANG, Newark, DE (US); Rong FAN, Katy, TX (US); Pavol PRANDA, Hockessin, DE (US); Robert A. GAGLIANO, Cochranville, PA (US); Benjamin J. JURCIK, JR., Landerberg, PA (US)

(73) Assignee: L'Air Liquide, Societe Anonyme pour l'Etude et l'Exploitation des Procedes Georges Claude, Paris (FR)

(21) Appl. No.: 15/417,892

(22) Filed: Jan. 27, 2017

(51) Int. Cl. C01B 3/36; B01D 53/047; C01B 3/56; C10L 3/10

(52) U.S. Cl. CPC C01B 3/36; B01D 53/047; C01B 3/56; C10L 3/103; B01D 2256/16; C01B 2203/1264; B01D 2257/504; B01D 2257/7025; C01B 2203/0255; C01B 2203/042; C01B 2203/1241; B01D 2257/502

(57) ABSTRACT

An improved hydrogen generation system and method for using the same are provided. The system includes an HDS unit configured to remove sulfur from a process gas and a fuel gas, a pre-reformer configured to convert heavy hydrocarbons in the process gas and the fuel gas to methane, a first heat exchanger configured to dry the pre-reformed fuel gas, a second heat exchanger configured to heat the dry pre-reformed fuel gas, and a reformer configured to produce a syngas and flue gas.

### TECHNICAL FIELD OF INVENTION

Disclosed are systems and methods for maximizing combustion efficiency in steam methane reformers (SMRs) through pre-heating a desulfurized pre-reformed fuel gas stream. In particular, fuel gas is desulfurized and pre-reformed by a pre-reformer in a SMR, and the desulfurized pre-reformed fuel gas is cooled down to remove water and then heated up to be fed to a reformer.

### BACKGROUND OF THE INVENTION

In large scale SMRs, approximately 50% of thermal energy input from burners is transferred to SMR reforming tubes to provide energy to drive the endothermic steam methane reforming reaction, CH₄+H₂O+206 kJ/mol [symbol] CO+3H₂ to produce a syngas (CO+H₂). Since the reforming reaction is generally carried out at a high temperature, e.g., 750° C. to 950° C., the temperature of a flue gas from the burner is generally at this temperature or above. Currently, the main usages of the high temperature flue gas are to generate steam through a waste heat boiler or a flue gas boiler and/or to preheat combustion air. The steam may be used as a process steam for the SMRs and/or an export steam to customer. The steam may also be used to drive a generator depending upon the local requirements which may vary from site to site.

U.S. Pat. No. 8,187,363 issued to Grover, et al. discloses a method of pre-heating of pressure swing adsorber (PSA) tail gas using low level waste heat in the flue gas or syngas prior to introduction into the SMR furnace combustion system. However, Grover does not disclose a detailed implementation and does not disclose a method of pre-heating of fuel gas.

### SUMMARY OF THE INVENTION

The present invention is directed to a system and a method for using the same that satisfy at least one of these needs. The present invention is directed to a system and a method for use the same that satisfy the need to increase thermal efficiency of SMRs. Certain embodiments of the present invention relate to converting heavy hydrocarbons to methane in the fuel gas and the process gas by a pre-reformer in order to increase the amount of methane in the fuel gas and the process gas. Embodiments of the invention allow the SMR to run more efficiently because the pre-reformed fuel gas stream is dried and heated using a processing stream available in the system, respectively.

In one embodiment, the system includes a hydrodesulfurization (HDS) unit configured to desulfurize the hydrocarbon gas stream to produce a desulfurized hydrocarbon gas stream, a pre-reformer configured to receive the desulfurized hydrocarbon gas stream and convert heavy hydrocarbons within the desulfurized hydrocarbon gas stream to methane to produce a pre-reformed process gas stream and a pre-reformed fuel gas stream, a first heat exchanger configured to cool the fuel gas stream to a temperature below the dew point of water to remove water contained within the fuel gas stream producing a dry fuel gas stream, a second heat exchanger configured to heat the dry fuel gas stream forming a heated dry fuel gas stream, a reformer having a combustion zone and a reaction zone, wherein the combustion zone is in fluid communication with the second heat exchanger and configured to receive the heated dry fuel gas stream originating from the second heat exchanger, wherein the reaction zone is in fluid communication with the pre-reformer and configured to receive the process gas stream originating from the pre-reformer, wherein the reformer is configured to produce a syngas stream within the reaction zone and a flue gas within the combustion zone in the presence of combustion oxidant, and a pressure swing adsorption (PSA) unit configured to receive the syngas stream and produce a product hydrogen stream and a PSA off-gas stream.

In one embodiment, the method includes the steps of: a) desulfurizing the hydrocarbon gas stream to produce a desulfurized hydrocarbon gas, b) pre-reforming the desulfurized hydrocarbon gas in the presence of water to produce a pre-reformed process gas and a pre-reformed fuel gas by converting heavy hydrocarbons within the desulfurized hydrocarbon gas to methane, c) drying the fuel gas stream by cooling the fuel gas stream to a temperature below the dew point of water producing a dry fuel gas stream, d) heating the dry fuel gas stream to form a heated dry fuel gas stream, e) converting methane within the process gas stream into carbon monoxide and hydrogen, thereby producing a syngas stream in a reaction zone of a reformer and a flue gas stream in a combustion zone of the reformer through combusting the heated dry fuel gas stream in the combustion zone of the reformer in the presence of combustion oxidant, wherein the combustion chamber is configured to exchange heat with the reaction zone, and f) introducing the syngas stream into a pressure swing adsorption (PSA) unit under conditions effective for producing a product hydrogen stream and a PSA off-gas stream.

Optional embodiments also include:
wherein the first heat exchanger uses a process stream selected from the group consisting of combustion air, the PSA off-gas, the hydrocarbon gas stream, and combinations thereof, to dry the fuel gas stream;
wherein the second heat exchanger uses a process stream selected from the group consisting of the hot flue gas, the syngas stream, and combinations thereof, to heat the dry fuel gas stream;
wherein the first heat exchanger uses combustion air to dry the fuel gas stream and the second heat exchanger uses the hot flue gas stream to heat the dry fuel gas stream;
wherein the first heat exchanger uses the PSA off-gas to dry the fuel gas stream and the second heat exchanger uses the hot flue gas stream to heat the dry fuel gas stream;
wherein the first heat exchanger uses the hydrocarbon gas stream to dry the fuel gas stream and the second heat exchanger uses the hot flue gas stream to heat the dry fuel gas stream;
wherein the first heat exchanger uses combustion air to dry the fuel gas stream and the second heat exchanger uses the syngas gas stream to heat the dry fuel gas stream;
wherein the first heat exchanger uses the PSA off-gas to dry the fuel gas stream and the second heat exchanger uses the syngas gas stream to heat the dry fuel gas stream;
wherein the first heat exchanger uses the hydrocarbon gas stream to dry the fuel gas stream and the second heat exchanger uses the syngas gas stream to heat the dry fuel gas stream;
a hydrocarbon source comprising a natural gas pipeline;
wherein the reformer is a steam methane reformer and the reaction zone comprises reforming tubes;
wherein the per-former is an adiabatic pre-reformer which includes an insulated vessel filled with a pre-reforming catalyst;
wherein the fuel gas stream is dried in step c) using a process stream selected from the group consisting of a combustion air, the PSA off-gas, the hydrocarbon gas, and combinations thereof;
wherein the dry fuel gas stream is heated in step d) using a process stream selected from the group consisting of the flue gas, the syngas stream, and combinations thereof;
wherein the hydrocarbon is natural gas; and/or
wherein the combustion oxidant is air.

### BRIEF DESCRIPTION OF THE FIGURES

For a further understanding of the nature and objects of the present invention, reference should be made to the following detailed description, taken in conjunction with the accompanying drawings, in which like elements are given the same or analogous reference numbers and wherein:

FIG. 1 illustrates a block flow diagram of an embodiment of an SMR system of the present invention;

FIG. 2 illustrates a block flow diagram of a second embodiment of an SMR system of the present invention;

FIG. 3 illustrates a block flow diagram of a third embodiment of an SMR system of the present invention;

FIG. 4 illustrates a block flow diagram of a fourth embodiment of an SMR system of the present invention;

FIG. 5 illustrates a block flow diagram of a fifth embodiment of an SMR system of the present invention;

FIG. 6 illustrates a block flow diagram of a sixth embodiment of an SMR system of the present invention; and

FIG. 7 illustrates a flowchart of a method for maximizing combustion efficiency in a SMR system in accordance with an embodiment of the present invention.

### DETAILED DESCRIPTION OF THE INVENTION

While the invention will be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

One of the challenges for optimal design and operation of a SMR is that the demand for hydrogen may be decoupled from the demand for the export steam from a reformer. Many refiners have little or no use for the export steam generated in a hydrogen plant, which is therefore considered of low value. In case steam value is very low and natural gas (NG) price is relatively high, it is desirable to utilize the excess energy in the flue gas stream and the syngas stream for other applications other than generating steam.

There have been numerous efforts to improve the thermal efficiency of standard SMRs. Pinch analyses show that the standard SMRs have been thermally well optimized, and therefore, further improvements related to heat exchanger designs are unlikely to yield much improvement. However, embodiments of the present invention can advantageously improve methods known heretofore by more effectively recovering waste heat without trying to re-optimize the process by overcoming temperature pinch.

Disclosed embodiments provide a straightforward approach in that a low temperature stream is used to cool a desulfurized pre-reformed fuel gas stream down to a temperature below the dew point of water for removing water to form a dry pre-reformed fuel gas stream and a high temperature stream is used to heat up the dry pre-reformed fuel gas stream to form a heated dry pre-reformed fuel gas stream fed to a reformer in order to maximize combustion efficiency in SMRs. By pre-reforming a fuel gas stream, disclosed systems, processes and methods may increase the combustion efficiency up to 5% compared to conventional SMRs.

In certain embodiments, the low temperature stream may be a process stream having a temperature at ambient temperature or around ambient temperature. In another embodiment, the low temperature stream can include a PSA off-gas, a cold combustion air at ambient temperature, a hydrocarbon gas (e.g., natural gas) at ambient temperature for use as process gas and/or fuel gas, or combinations thereof.

In certain embodiments, the high temperature stream can be a process stream having a temperature at around the reforming reaction temperature or product temperature (e.g., 750° C. to 950° C.) in the SMR. In another embodiment, the high temperature stream can include the flue gas stream and/or syngas stream generated from the reformer having a temperature around the reforming reaction temperature or reforming product temperature. In certain embodiments, both process gas and fuel gas are desulfurized and pre-reformed.

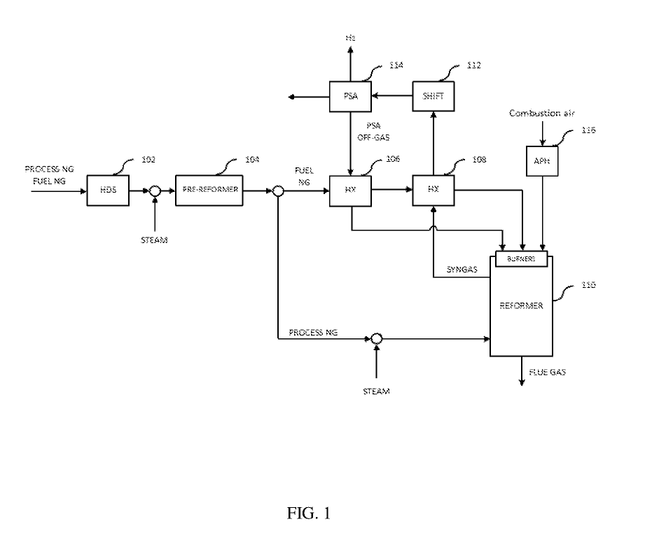

FIG. 1 illustrates a block flow diagram of an embodiment of an SMR system using a PSA off-gas stream as a low temperature stream and using a syngas stream as a high temperature stream. As illustrated, a hydrocarbon gas, e.g., natural gas, for use as process gas and fuel gas is pre-heated (not shown) and sent to hydrodesulfurization unit (HDS) 102 where sulfur in the natural gas is removed.

After removing sulfur, the natural gas is mixed with steam or water vapor and forwarded to pre-reformer 104 for breaking down long chain or heavy hydrocarbons in the natural gas into light hydrocarbons (e.g., methane) to produce a pre-reformed natural gas for use as fuel and process gas, thereby increasing the amount of methane within the natural gas and avoiding carbon deposition or coking caused by heavier or higher hydrocarbons in reformer 110 when the temperature of the product gas is increased.

In a preferred embodiment, the pre-reformer catalyst is specifically designed for removing heavy hydrocarbons. Therefore, only heavy hydrocarbons may be converted to methane. In a preferred embodiment, the HDS unit (herein HDS 102) is used upstream of the pre-reformer in order to remove sulfur. As a result, the pre-reformer catalyst poison by the sulfur and sulfuric acid/sulphate condensation in a low temperature portion of the flue gas channel may be eliminated.

After pre-reforming, the pre-reformed natural gas is split into two streams. One stream is used as a process gas; the other stream is used as a fuel gas. Reformer 110 can include a reaction zone and a combustion zone, wherein the reaction zone contains a plurality of reforming tubes, and the combustion zone includes a plurality of burners and a combustion chamber, wherein the combustion chamber is configured to exchange heat with the reaction zone. The process gas is introduced into the reforming tubes of reformer 110 in the presence of steam under reforming conditions effective for converting methane within the process gas stream into carbon monoxide (CO) and hydrogen (H₂) through the endothermic reaction (CH₄+H₂O+206 kJ/mol⇄CO+H₂), thus, producing a syngas stream (H₂+CO).

Following pre-reformer 104, the pre-reformed fuel gas is still wet. While the presence of water is preferable for the pre-reformed process gas (since the reforming reaction uses water), water vapor in the fuel gas is not desired, since the water vapor does not provide any combustion duty, and therefore, would just absorb combustion heat during combustion thereby reducing the efficiencies of combustion. Therefore, in embodiments of the present invention, the pre-reformed fuel gas is dried, which can be achieved by cooling the pre-reformed fuel gas to a temperature below the dew point of water in low temperature heat exchanger HX 106. Following drying, the dried fuel gas stream is preferably heated up in a higher temperature heat exchanger HX 108 before being sent to the burners in order to improve combustion efficiencies. The various figures provide various examples of which process streams can provide low temperature cooling by HX 106 or higher temperature heating by HX 108.

Now turning back to FIG. 1, the pre-reformed fuel gas is cooled in HX 106 by heat exchange with a PSA off-gas stream generated from PSA unit 114 down to a temperature below the dew point of water to produce a dry fuel gas stream. Here, by removing water from the fuel gas, the relative natural gas or methane content within the fuel gas is increased, so that offering the possibility of significant fuel cost reduction and higher system combustion efficiencies comparing to the conventional SMRs. In addition, by cooling the pre-reformed fuel gas, the PSA off-gas is heated up and the heated PSA off-gas is fed to the burners of reformer 110 for use as fuel. The dry fuel gas stream is subsequently heated up in HX 108 by heat exchange with the syngas stream therein. The heated dry fuel gas stream is then fed to the burners of reformer 110 where the burners combust the heated dry fuel gas, the PSA off-gas in the combustion chamber in the presence of a pre-heated combustion air introduced from air pre-heater (APH) 116, thus, providing heat for the endothermic reforming reaction conducted in the reforming tubes of the reaction zone of reformer 110 and producing a flue gas therefrom.

The flue gas and the syngas are removed from reformer 110, in which the syngas is used for heating up the dry pre-reformed fuel gas by heat exchange in HX 108 as described above (i.e., higher temperature heat recovery), while the flue gas is used for recovering heat by various heat exchange processes, for example, generating steam, heating the combustion air (not shown). After heating up the dry fuel gas stream, the syngas is converted to carbon dioxide (CO₂) and hydrogen (H₂) in shift unit 112 through a water gas-shift reaction (CO+H₂O⇄CO₂+H₂), to produce additional H₂ thereby forming a shifted gas. The shifted gas is cooled further down to ambient temperature to knock out water before entering PSA unit 114. A product H₂ stream and the PSA off-gas stream are consequently produced from PSA unit 114. The PSA-off-gas includes CO, CO₂, H₂, and CH₄.

In this embodiment, before sending back to reformer 110 for use as fuel, the PSA off-gas passes through HX 106 to cool the pre-reformed fuel gas stream down to a temperature below the dew point of water to produce the dry pre-reformed fuel gas stream. This also advantageously pre-heats the PSA off-gas. The pre-heated PSA off-gas is then sent back to reformer 110 for use as fuel. In the embodiment shown, a cold combustion air at ambient temperature can be pre-heated in APH 116 to form the pre-heated combustion air fed to the burners of reformer 110 for combusting the heated dry pre-reformed fuel gas and the pre-heated PSA off gas in the combustion chamber of reformer 110.

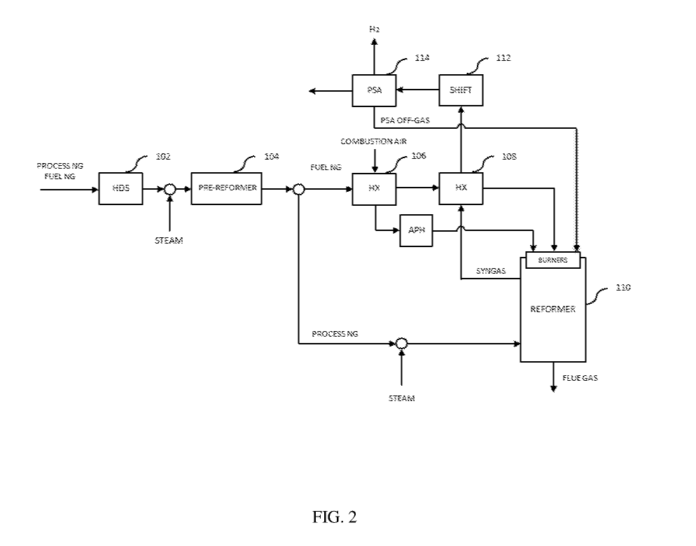

FIG. 2 illustrates a block flow diagram of a second embodiment of an SMR system of the present invention using the cold combustion air stream as the low temperature stream and using the syngas stream as the high temperature stream. The difference between the embodiments illustrated in FIG. 2 and FIG. 1 is the cold combustion air at ambient temperature is used in HX 106 in FIG. 2 to cool down the desulfurized pre-reformed fuel gas stream in order to remove water therein. In this embodiment, the PSA off-gas produced from PSA unit 114 is herein directly sent back to reformer 110 for use as fuel without pre-heating. Alternatively, the PSA off-gas produced from PSA unit 114 may be pre-heated by a heat exchanger through heat exchange with a waste stream such as the flue gas or a syngas downstream of PSA unit 114 and then sent back to reformer 110. Furthermore, the desulfurized pre-reformed fuel gas downstream of pre-reformer 104 is cooled in HX 106 by heat exchange with a cold combustion air at ambient temperature down to a temperature below the dew point of water to produce a dry fuel gas stream. By cooling the pre-reformed fuel gas, the cold combustion air is heated up and the heated combustion air is further heated up with APH 116. After that, the further heated combustion air is fed to the burners of reformer 110 for use as combustion air.

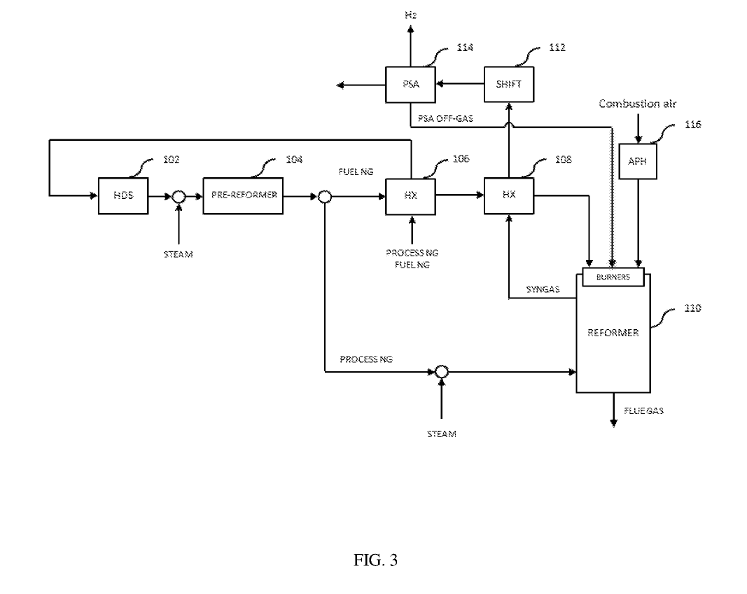

FIG. 3 illustrates a block flow diagram of a third embodiment of an SMR system of the present invention using the hydrocarbons gas (e.g., natural gas) at ambient temperature as the low temperature stream and using the syngas stream as the high temperature stream. The difference between the embodiments illustrated in FIG. 3 and FIG. 2 is a feedstock of the hydrocarbon gas at ambient temperature is used in HX 106 of FIG. 3 to cool the fuel gas stream in order to remove water in the fuel gas, rather than using the cold combustion air. In this embodiment, a feedstock of the natural gas is pre-heated by heat exchange with the pre-reformed fuel gas in HX 106. After pre-heated, the natural gas is forwarded to HDS 102 where sulfur in the natural gas is removed. The fuel gas downstream of pre-reformer 104 is cooled in HX 106 by heat exchange with the natural gas down to a temperature below the dew point of water to remove water producing a dry fuel gas stream. By cooling the pre-reformed fuel gas, the natural gas is heated up, as described above. Herein, a cold combustion air at ambient temperature is pre-heated in APH 116 to form the pre-heated combustion air.

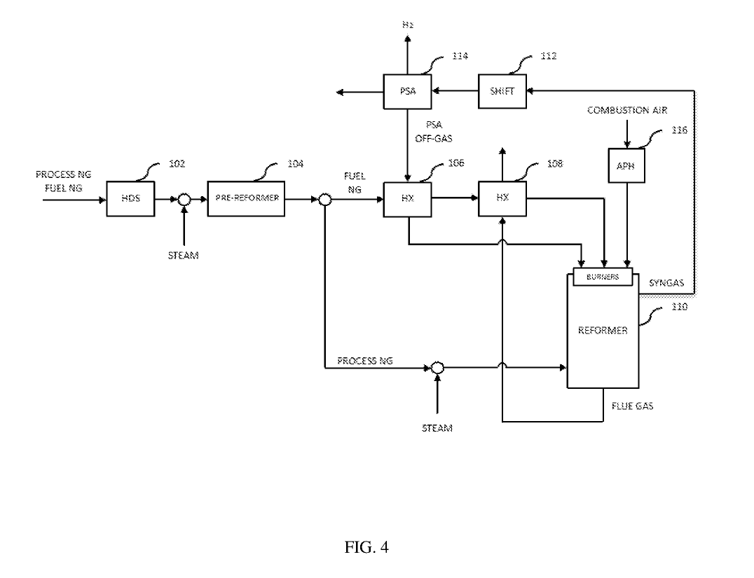

FIG. 4 illustrates a block flow diagram of a fourth embodiment of an SMR system of the present invention using the PSA off-gas stream as the low temperature stream and the flue gas stream as the high temperature stream. The difference between the embodiments illustrated in FIG. 4 and FIG. 1 is the flue gas stream is used as the high temperature stream in HX 108 of FIG. 4 to heat the dry fuel gas.

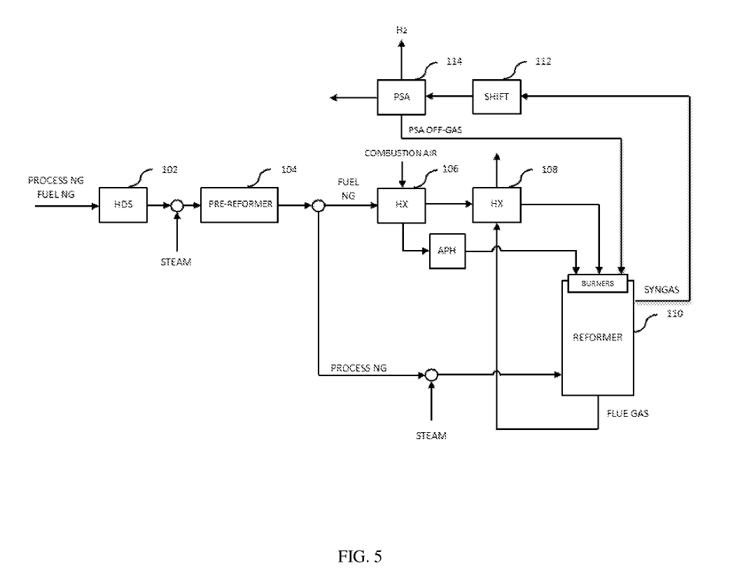

FIG. 5 illustrates a block flow diagram of a fifth embodiment of an SMR system of the present invention using the cold combustion air as the low temperature stream and the flue gas stream as the high temperature stream. The difference between the embodiments illustrated in FIG. 5 and FIG. 2 is the flue gas stream is used as the high temperature stream in HX 108 of FIG. 5 to heat the dray fuel gas.

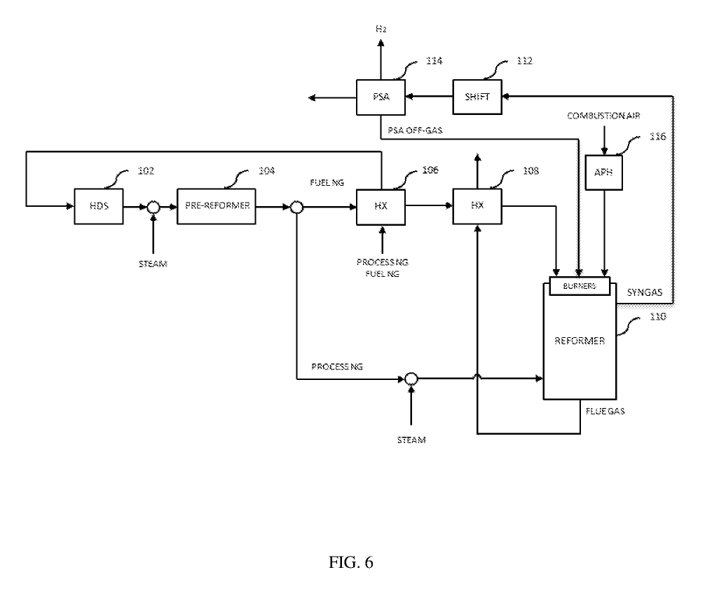

FIG. 6 illustrates a block flow diagram of a sixth embodiment of an SMR system of the present invention using the hydrocarbons gas at ambient temperature as the low temperature stream and the flue gas stream as the high temperature stream. The difference between the embodiments illustrated in FIG. 6 and FIG. 3 is the flue gas stream is used as the high temperature stream in HX 108 of FIG. 6 to heat the dray fuel gas.

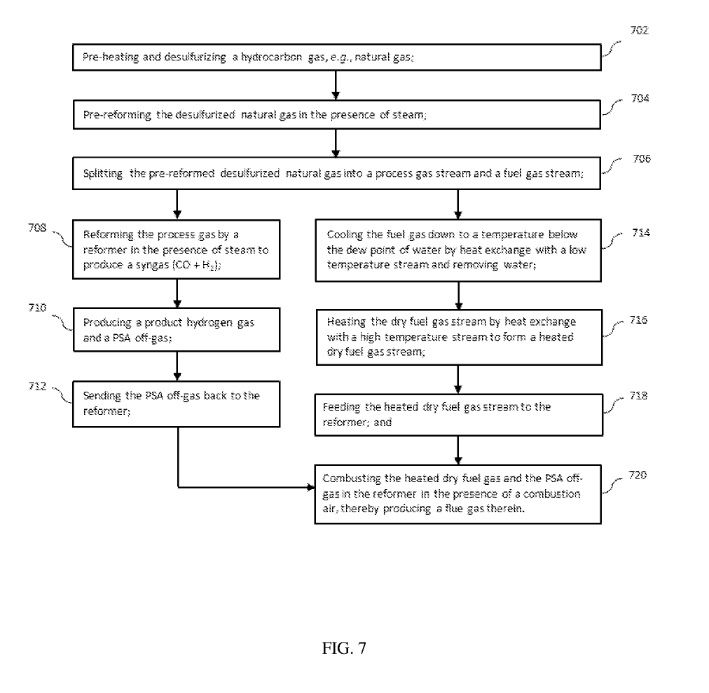

FIG. 7 illustrates a flowchart of a method for maximizing combustion efficiency in an SMR system of the present invention. At step 702, a hydrocarbon gas at ambient temperature for use as process gas and fuel gas is pre-heated and then desulfurized in the HDS unit to remove sulfur within the natural gas. At step 704, in the presence of steam, the desulfurized natural gas is pre-reformed in a pre-reformer to break down heavy hydrocarbons existing in the desulfurized natural gas into light hydrocarbons (e.g., methane) thereby increasing the amount of methane in the desulfurized natural gas and avoiding carbon deposition. At step 706, the pre-reformed desulfurized natural gas stream is split into two streams; one is used for a process gas, the other is used for a fuel gas. At step 708, the process gas can be fed to the reformer where a syngas stream is produced in the reaction zone and a flue gas stream is produced in the combustion zone. In certain embodiments, the reaction zone can include a plurality of reforming tubes, and the combustion zone can also contain a plurality of burners, wherein the combustion zone is configured to exchange heat with the reaction zone.

In certain embodiments, the pre-reformed process gas mixing with the process steam reacts in the reforming tubes in the reaction zone of the reformer thereby producing the syngas stream. A plurality of burners of the reformer combust the fuel gas and the PSA off-gas in the presence of an oxidant (e.g., the combustion air) in the combustion zone of the reformer for providing heat for the endothermic reforming reaction to produce the flue gas therefrom. As used herein, the combustion air can also include an oxygen enriched gas stream.

In certain embodiments, the process steam can be added to the process gas stream before the process gas stream entering the pre-reformer. The process steam can be also added to the pre-reformed process gas before the pre-reformed process gas entering the reformer. At step 710, the CO in the syngas can be converted to carbon dioxide (CO₂) and hydrogen (H₂) in the presence of the process steam in a shift converter for producing more H₂.

The converted syngas stream is cooled further down to ambient temperature to knock out water before entering a PSA unit. A product hydrogen stream and a PSA off-gas stream are consequently produced from the PSA unit. The PSA-off-gas includes CO, CO₂, H₂, and CH₄ and is fed back to the reformer for use as fuel at step 712. At step 714, in parallel with the process of reforming the process gas in the reformer at step 708, the fuel gas stream is dried by cooling it down to a temperature below the dew point of water by heat exchange with a low temperature stream forming a dry fuel gas stream. The low temperature stream can be selected from the group consisting of the PSA off-gas generated from the reformer, the cold combustion air at ambient temperature, the hydrocarbon feedstock for use as process gas and fuel gas at ambient temperature, and combinations thereof.

As noted previously, while cooling the fuel gas, the low temperature stream is advantageously pre-heated, which provides additional synergies (e.g., the PSA off-gas is pre-heated before sending back to the reformer, the cold combustion air is pre-headed before fed to the reformer for combusting the fuel gas and the PSA off-gas, and/or the natural gas for use as process gas and fuel gas is also pre-heated before fed to the HDS unit for removing sulfur). As a result, the wet pre-reformed fuel gas can be dried via heat exchange without wasting heat from the pre-reformed fuel gas.

At step 716, the dry fuel gas stream is heated by heat exchange with a high temperature stream forming a heated dry fuel gas stream. The high temperature stream can be selected from the group consisting of the syngas stream, the flue gas stream generated from the reformer, and combinations thereof. At step 718, the heated dry fuel gas stream is fed to the burners of the reformer for use as fuel. Finally, at step 720, the burners combust the heated dry fuel gas and the PSA off-gas in the presence of a pre-heated combustion air introduced from an air pre-heater in the combustion chamber of the reformer to produce the flue gas. The syngas produced at step 708 and/or the flue gas produced at this step may be used as the high temperature stream for heating the dry fuel gas herein at step 716.

The disclosed embodiments have several advantages over the conventional SMRs. First, by pre-reforming the fuel gas, heavy hydrocarbons in the fuel gas (e.g., natural gas) are broken down to light hydrocarbon, i.e., methane, resulting in an increase of methane and/or natural gas contents in the fuel gas, which offers the possibility of significant fuel cost reduction and higher system combustion efficiencies comparing to the conventional SMRs.

Second, by removing water from the fuel gas, the natural gas or methane content in the fuel gas is also relatively increased, thereby offering the possibility of significant fuel cost reduction and higher system combustion efficiencies comparing to the conventional SMRs. Furthermore, by cooling the pre-reformed desulfurized fuel gas down to a temperature below the dew point of water to remove water, the low temperature streams, such as, the PSA off-gas, the cold combustion air, the natural gas feedstock at ambient temperature, or combinations thereof, can be pre-heated, thereby recycling heat from the pre-reformed desulfurized fuel gas.

Third, the natural gas for use as fuel gas and process gas is desulfurized. This means that the energy of either the flue gas or the syngas below the sulfuric acid dew point may be utilized, so that the sulfuric acid condensation in the system is eliminated. In other words, since sulfur is removed in the fuel gas stream, the temperature of the flue gas can be reduced below the dew point of sulfuric acid without sulfuric acid condensation in the SMR system, which helps to eliminate corrosion of the equipment operated in the low temperature range. In certain embodiments, this advantageously allows for use of carbon steel instead of stainless steel.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations that fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

Note that herein, the terms “heavy hydrocarbon”, “heavier hydrocarbon”, “higher hydrocarbon” and “long chain hydrocarbon” refer to C₂ and C₂₊ hydrocarbon and may be used interchangeably.

The singular forms “a”, “an” and “the” include plural referents, unless the context clearly dictates otherwise.

“About” or “around” or “approximately” in the text or in a claim means±10% of the value stated.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A system for reforming a hydrocarbon gas stream to hydrogen, the system comprising:
a hydrodesulfurization unit configured to desulfurize the hydrocarbon gas stream to produce a desulfurized hydrocarbon gas stream;
a pre-reformer configured to receive the desulfurized hydrocarbon gas stream and convert heavy hydrocarbons within the desulfurized hydrocarbon gas stream to methane to produce a pre-reformed process gas stream and a pre-reformed fuel gas stream;
a first heat exchanger configured to cool the pre-reformed fuel gas stream to a temperature below the dew point of water to remove water contained within the fuel gas stream producing a dry fuel gas stream;
a second heat exchanger configured to heat the dry fuel gas stream forming a heated dry fuel gas stream;
a reformer having a combustion zone and a reaction zone, wherein the combustion zone is in fluid communication with the second heat exchanger and configured to receive the heated dry fuel gas stream originating from the second heat exchanger, wherein the reaction zone is in fluid communication with the pre-reformer and configured to receive the process gas stream originating from the pre-reformer, wherein the reformer is configured to produce a syngas stream within the reaction zone and a flue gas within the combustion zone in the presence of combustion oxidant; and
a pressure swing adsorption (PSA) unit configured to receive the syngas stream and produce a product hydrogen stream and a PSA off-gas stream.

2. The system of claim 11, wherein the first heat exchanger uses a process stream selected from the group consisting of combustion air, the PSA off-gas, the hydrocarbon gas stream, and combinations thereof, to dry the fuel gas stream.

3. The system of claim 11, wherein the second heat exchanger uses a process stream selected from the group consisting of the hot flue gas, the syngas stream, and combinations thereof, to heat the dry fuel gas stream.

4. The system of claim 11, wherein the first heat exchanger uses combustion air to dry the fuel gas stream and the second heat exchanger uses the hot flue gas stream to heat the dry fuel gas stream.

5. The system of claim 11, wherein the first heat exchanger uses the PSA off-gas to dry the fuel gas stream and the second heat exchanger uses the hot flue gas stream to heat the dry fuel gas stream.

6. The system of claim 11, wherein the first heat exchanger uses the hydrocarbon gas stream to dry the fuel gas stream and the second heat exchanger uses the hot flue gas stream to heat the dry fuel gas stream.

7. The system of claim 11, wherein the first heat exchanger uses combustion air to dry the fuel gas stream and the second heat exchanger uses the syngas gas stream to heat the dry fuel gas stream.

8. The system of claim 11, wherein the first heat exchanger uses the PSA off-gas to dry the fuel gas stream and the second heat exchanger uses the syngas gas stream to heat the dry fuel gas stream.

9. The system of claim 11, wherein the first heat exchanger uses the hydrocarbon gas stream to dry the fuel gas stream and the second heat exchanger uses the syngas gas stream to heat the dry fuel gas stream.

10. The system of claim 1, further comprising a hydrocarbon source comprising a natural gas pipeline.

11. The system of claim 1, wherein the reformer is a steam methane reformer and the reaction zone comprises reforming tubes.

12. The system of claim 1, wherein the per-former is an adiabatic pre-reformer which includes an insulated vessel filled with a pre-reforming catalyst.

13. A method for reforming a hydrocarbon gas to hydrogen, the method comprising the steps of:
a) desulfurizing the hydrocarbon gas stream to produce a desulfurized hydrocarbon gas;
b) pre-reforming the desulfurized hydrocarbon gas in the presence of water to produce a pre-reformed process gas and a pre-reformed fuel gas by converting heavy hydrocarbons within the desulfurized hydrocarbon gas to methane;
c) drying the fuel gas stream by cooling the fuel gas stream to a temperature below the dew point of water producing a dry fuel gas stream;
d) heating the dry fuel gas stream to form a heated dry fuel gas stream;
e) converting methane within the process gas stream into carbon monoxide and hydrogen, thereby producing a syngas stream in a reaction zone of a reformer and a flue gas stream in a combustion zone of the reformer through combusting the heated dry fuel gas stream in the combustion zone of the reformer in the presence of combustion oxidant, wherein the combustion chamber is configured to exchange heat with the reaction zone; and
f) introducing the syngas stream into a pressure swing adsorption (PSA) unit under conditions effective for producing a product hydrogen stream and a PSA off-gas stream.

14. The method as claimed in claim 13, wherein the fuel gas stream is dried in step c) using a process stream selected from the group consisting of a combustion air, the PSA off-gas, the hydrocarbon gas, and combinations thereof.

15. The method as claimed in claim 13, wherein the dry fuel gas stream is heated in step d) using a process stream selected from the group consisting of the flue gas, the syngas stream, and combinations thereof.

16. The method of claim 11, wherein the hydrocarbon is natural gas.

17. The method of claim 11, wherein the combustion oxidant is air.
